(19) United States
(12) Patent Application Publication
(10) Pub. No.: US 2025/0212252 A1
(43) Pub. Date: Jun. 26, 2025

(54) Machine Learning Based Optimizations of High Throughput Data Transfers

(71) Applicant: Cisco Technology, Inc., San Jose, CA (US)

(72) Inventors: Indermeet Gandhi, San Jose, CA (US); Robert Barton, VANCOUVER (CA); Jerome Henry, Pittsboro, NC (US); Juan Carlos Zuniga, MONTREAL (CA); Federico Lovison, Fontanelle (IT)

(21) Appl. No.: 18/586,361

(22) Filed: Feb. 23, 2024

Related U.S. Application Data
(60) Provisional application No. 63/614,904, filed on Dec. 26, 2023.

(51) Int. Cl. H04W 74/0816

(52) U.S. Cl. CPC H04W 74/0816

(57) ABSTRACT

Systems, methods, and further embodiments herein relate to optimizing wireless network transmissions. In many high throughput data transmission methods, such as, but not limited to, enhanced distributed channel access (EDCA) methods, data selected for transmission can be separated into two or more categories. Embodiments described herein can derive and apply one or more machine-learning methods to take input data associated with the high throughput data transmission methods to get a plurality of data transmission settings on a per-category basis. In some embodiments, these settings can be transmitted and applied to various network devices such as access points, which can allow for a more optimized and efficient use of available network bandwidth. In certain embodiments, these settings can be associated with the various values associated with contention windows, which can be utilized to determine how aggressively data is transferred over a wireless network connection.

### CROSS-REFERENCE TO RELATED APPLICATION

This application claims the benefit of U.S. Provisional Patent Application No. 63/614,904, filed Dec. 26, 2023, which is incorporated by reference herein in its entirety.

The present disclosure relates to wireless networking. More particularly, the present disclosure relates to machine-learning based optimizations in wireless protocols.

### BACKGROUND

Wireless fidelity (“Wi-Fi”) is of paramount importance in the modern era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

Specifically, the Enhanced Distributed Channel Access (EDCA) mechanism in 802.11 Wi-Fi allows for the configuration of channel access timers like the contention windows (CWmin/CWmax) and arbitration interframe space (AIFS), and TXOP for each access category (AC). Current Wi-Fi deployments predominantly rely on standard recommended EDCA parameter values defined in the 802.11 specifications. These values are often static across all categories of data.

### SUMMARY OF THE DISCLOSURE

Systems and methods for machine-learning based optimizations in wireless protocols in accordance with embodiments of the disclosure are described herein. In some embodiments, a network management logic is configured to transmit one or more beacon frames, gather a plurality of input data, process the input data through one or more machine-learning-based models, derive a plurality of data transmission settings, and transmit the plurality of data transmission settings to at least one network device.

In some embodiments, the one or more beacon frames is modified to indicate a capacity for high throughput operation.

In some embodiments, input data includes at least one of telemetry data, historical data, or parameter data.

In some embodiments, telemetry data may include at least one of collision rates, transfer success rates, background noise, a quantity of devices being serviced, one or more applications being utilized, quality of service policies, or interference.

In some embodiments, the one or more machine-learning-based models is an inference model.

In some embodiments, the network management logic is further configured to receive the inference model prior to processing the input data.

In some embodiments, the inference model is received in response to a request transmitted by the device.

In some embodiments, the plurality of data transmission settings are associated with an enhanced distributed channel access (EDCA) method.

In some embodiments, the EDCA method is configured to parse transmitted data into two or more categories.

In some embodiments, the plurality of data transmission settings are configured to provide unique settings for each of the two or more categories.

In some embodiments, the plurality of data transmission settings are configured to provide unique settings for at least two of the two or more categories.

In some embodiments, the plurality of data transmission settings are associated with contention window timings.

In some embodiments, a network management logic is further configured to transmit data to the at least one network device utilizing an enhanced distributed channel access (EDCA) method.

In some embodiments, a network management logic is configured to receive at least one beacon frame, indicate a capability for high throughput data transmission, enable a high throughput data transmission mode, receive a plurality of data transmission settings associated with the high throughput data transmission, and change one or more parameters of the high throughput data transmission mode.

In some embodiments, indicating a capability for high throughput data transmission includes setting an element bit within an associate frame request.

In some embodiments, the high throughput data transmission mode is an enhanced distributed channel access (EDCA) method.

In some embodiments, the EDCA method parses data for transmission into two or more categories.

In some embodiments, the plurality of data settings are configured to direct a change in each of the two or more categories.

In some embodiments, the network management logic is further configured to transmit data utilizing the high throughput transmission mode.

In some embodiments, managing a network includes transmitting one or more beacon frames, selecting a high throughput data transmission mode wherein the data selected for transmission is separated into two or more categories, gathering a plurality of input data associated with the high throughput data transmission mode, processing the input data through one or more machine-learning-based models, deriving a plurality of data transmission settings, wherein the plurality of data transmission settings are configured on a per-category basis, and transmitting the plurality of data transmission settings to at least one network device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a conceptual depiction of a communication layer architecture in accordance with various embodiments of the disclosure, in accordance with various embodiments of the disclosure;

FIG. 3 is a conceptual network diagram of various environments that a networking logic may operate on a plurality of network devices, in accordance with various embodiments of the disclosure; and

FIG. 4 is a conceptual illustration of an artificial neural network, in accordance with various embodiments of the disclosure;

FIG. 5 is a flowchart depicting a process for machine-learning based optimization of enhanced distributed channel access in accordance with various embodiments of the disclosure;

FIG. 6 is a flowchart depicting a process for deploying a trained inference model in accordance with various embodiments of the disclosure;

FIG. 7 is a flowchart depicting a process for utilizing inference models to derive enhanced distributed channel access parameters in accordance with various embodiments of the disclosure;

FIG. 8 is a flowchart depicting a process for changing enhanced distributed channel access parameters on a per-category basis in accordance with various embodiments of the disclosure; and

FIG. 9 is a conceptual block diagram of a device suitable for configuration with a network management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In many current methods, Enhanced Distributed Channel Access (EDCA) parameters on a given wireless local area network (WLAN) are static and do not change, even as network conditions may change. In Wi-Fi networking, EDCA stands for Enhanced Distributed Channel Access. It is a mechanism defined in the IEEE 802.11e standard, an extension to the original IEEE 802.11 standard that introduces Quality of Service (QOS) enhancements. EDCA is designed to improve the prioritization and access to the wireless medium for different types of traffic, allowing for a more efficient and predictable transmission of data.

EDCA operates by dividing the traffic into four access categories (ACs), each with a different priority level. These access categories are often categorized as voice, video, best effort, and background. Within each access category, a contention mechanism is employed, allowing network devices to access the channel based on their priority. Network devices with a higher priority can have a better chance of accessing the channel compared to lower-priority stations. By using EDCA, Wi-Fi networks can provide a differentiated Quality of Service (QOS) for various applications and services, ensuring that time-sensitive traffic, such as voice or video, can receive preferential treatment over less time-sensitive data. This contributes to a more responsive and efficient wireless communication environment.

In Wi-Fi networking, a contention window is a parameter used in the Carrier Sense Multiple Access with Collision Avoidance (CSMA/CA) protocol. CSMA/CA is a method employed by Wi-Fi devices to share the medium (the wireless channel) and avoid collisions when transmitting data. The contention window is a range of time during which a Wi-Fi device waits before attempting to transmit a frame after determining that the wireless channel is busy. When a device needs to transmit data, it first listens to the channel. If the channel is busy, the device waits for a random duration within the contention window before checking the channel again. If the channel is still busy, it continues to wait for additional random time periods within the contention window until it finds an idle channel to transmit.

The size of the contention window is dynamic and can be adjusted based on network conditions. After a successful transmission, the contention window size may be reset to a minimum value. In contrast, collisions or unsuccessful transmissions may result in an increase in the contention window size, helping to avoid repeated collisions. The use of contention windows is a part of the mechanism to manage access to the shared wireless medium in a fair and efficient manner, preventing multiple devices from attempting to transmit simultaneously and causing collisions in the network.

The contention windows can be utilized in the EDCA process. When a device needs to transmit data, it waits for the channel to be idle and then randomly selects a backoff value within its contention window, which is determined by two parameters—the initial contention window (CWmin) and the maximum contention window (CWmax). Each Access Category has its own set of contention window parameters, with higher-priority categories having smaller contention windows. This design allows higher-priority traffic to contend for the channel more frequently with shorter waiting times, ensuring timely access. The backoff process involves choosing a random backoff value within the specified contention window, and if a transmission attempt fails, the contention window may be adjusted by doubling its size, adapting dynamically to the network conditions. Through these mechanisms, EDCA aims to provide differentiated Quality of Service (QOS) by prioritizing certain types of traffic in Wi-Fi networks based on their contention window parameters.

Arbitration Interframe Spaces (AIFS) are time intervals integral to Wi-Fi networks, particularly within the EDCA mechanism. In the context of EDCA, distinct Access Categories (ACs) are established, each assigned a specific priority level ranging from Background to Voice. The AIFS represents the duration a network device must wait after the wireless channel becomes available before initiating a transmission attempt. Crucially, higher-priority Access Categories are associated with shorter AIFS durations, enabling them to contend for the channel more promptly. This prioritization is essential in the backoff process, where a network device selects a random backoff value within its contention window after the AIFS duration elapses. The combined use of AIFS and contention window parameters can help to regulate the time a station must wait before attempting to transmit, contributing to collision avoidance, and improving an overall QoS.

In wireless networking, a TXOP, or Transmission Opportunity, refers to a time interval during which a wireless station or device has the exclusive right to transmit data over the wireless medium. It is a concept associated with the IEEE 802.11 standard, commonly known as Wi-Fi. The TXOP mechanism is designed to improve network efficiency and reduce contention by allocating specific time slots for data transmission. It helps in managing the shared communication medium by preventing multiple stations from attempting to transmit simultaneously, thereby reducing collisions, and enhancing overall network performance. The TXOP is part of the medium access control (MAC) layer in the IEEE 802.11 standard and plays a crucial role in optimizing the utilization of the available wireless bandwidth.

A beacon frame is a fundamental element in Wi-Fi networks, serving as a periodic broadcast by an Access Point (AP) to announce its presence and share critical information with nearby devices. This frame contains essential details about the network, including the network's Service Set Identifier (SSID), supported data rates, encryption methods, and the capability to indicate whether the network is open or requires authentication. In a Wi-Fi Beacon frame, the “Capabilities Information” element is a field that includes several bits indicating various capabilities of the Access Point (AP) or the Basic Service Set (BSS). One of the bits within the “Capabilities Information” element is the ESS (Extended Service Set) bit.

A High Throughput (HT) capabilities information element is part of the Beacon frame in networks that use the IEEE 802.11n standard or later. When the HT bit is set to 1, it signifies that the network supports high-throughput operations, including the use of multiple antennas, channel bonding, and advanced modulation schemes. The presence of the HT capabilities in the Beacon frame allows compatible Wi-Fi devices to identify and connect to networks that offer higher data rates and improved performance in comparison to earlier Wi-Fi standards.

On the other hand, an association request frame is used by a Wi-Fi client device to initiate the process of joining a wireless network. When a client device intends to connect to a specific AP, it sends an association request frame to that AP. This frame includes information such as the client's MAC address, supported data rates, and any additional capabilities. The association request is part of the initial handshake between the client and the AP, signaling the client's intention to become part of the wireless network. Upon receiving the association request, the AP can respond with an association response frame to either accept or reject the client's request, depending on factors like network capacity, security settings, and authentication status. Together, these frames play a key role in establishing and maintaining Wi-Fi connections within a network. The association request frame may also include an HT bit that can be set.

In many embodiments described herein, WLAN may undergo varying client densities, diverse traffic patterns, fluctuating interference, and shifting application demands. Static EDCA configurations lead to suboptimal channel access scheduling in many practical deployment scenarios. In some dense scenarios, Wi-Fi networks, large contention windows cannot prevent excessive collisions, degrading user experience. Smaller contention window (CW) sizes are needed to meet access delay requirements. In additional embodiments, when traffic is presented in bursts, fixed EDCA parameters cause temporary spikes in collisions and congestion, reducing network capacity. Adaptive tuning is necessary to maximize throughput. In more scenarios, if multiple applications with diverse QoS needs share an AC, their performance cannot be differentiated with static parameters. This prevents meeting application SLAs. In additional scenarios, time-varying radio conditions due to interference and user mobility require continual EDCA adaptation to achieve reliable channel access. In more scenarios, with IoT devices that sporadically transmit small data packets, fixed EDCA parameters lead to highly inefficient channel utilization.

To truly maximize Wi-Fi network efficiency and performance, an intelligent optimization engine is needed that can find the ideal EDCA parameters for each AC in real-time, and be based on actual operating conditions. Leveraging advanced machine learning techniques can enable data-driven optimization of EDCA parameters tailored to network dynamics, traffic patterns, and application demands.

It should be noted that although EDCA was designed for contention-based media access and is primarily used prior to the OFDMA method used in Wi-Fi 6 and beyond, the techniques described herein still apply. Even in Wi-Fi 6 and beyond, media access is split into a Scheduled Access (SA) portion, governed by the rules of OFDMA, and a Random Access (RA) portion, which inherits the characteristics of EDCA media access.

In many embodiments, an intelligent optimization engine can be configured that can find the ideal Enhanced Distributed Channel Access (EDCA) parameters for each Access Category (AC) in real-time or near-real-time, and be based on actual operating conditions. Leveraging advanced machine learning techniques can enable data-driven optimization of EDCA parameters tailored to network dynamics, traffic patterns, and application demands.

In further embodiments, an intelligent engine for optimizing random access performance in future Wi-Fi networks is proposed by dynamically adapting EDCA parameters based on network conditions using the following machine learning based approach. In certain embodiments, the AP and devices exchange capabilities to establish support for ML-driven EDCA optimization. Specifically, the AP sets the HT+ (high throughput) capabilities element bit in Beacon frames to indicate availability of optimization. devices that also support this capability respond by setting the HT+ capabilities bit in the Association Request frame. This signaling verifies compatibility between the AP and devices for optimized EDCA tuning.

In more embodiments, a multi-dimensional dataset is constructed to train the ML model by capturing various network environments under different conditions. The number of clients, types of application traffic, congestion levels, and interference profiles are varied across scenarios to represent heterogeneous deployments. Numerous EDCA configurations spanning a wide range of contention parameter values are evaluated to characterize the impact on performance. Important input features that represent network state are collected, including per-AC traffic load, queue depth, and airtime usage statistics. Performance is quantified through key output metrics like throughput, latency, and reliability per AC. Measurements are taken over time as conditions vary to provide a robust training dataset covering diverse scenarios.

In additional embodiments, using this dataset a learning machine, such as an Artificial Neural Network (ANN) can be used to learn the complex relationships between the input variables which include various wireless device conditions, RF characteristics, all the EDCA timers, and an objective function (wireless network performance) all on a per-AC basis. Notably, these input variables are compared against one or more objective functions, primarily, but not limited to, wireless network performance (either in aggregate for an AP, or on a per-AC basis).

In the previous step(s), the trained ANN can be used as a surrogate model to approximate the relationships between the input variables and the objective function (overall network performance). Once the surrogate model is trained, an optimization function must be applied to find the best EDCA timer set. Here, we employ a mechanism such as a Bayesian Optimizer. In the field of data science Bayesian Optimizers use an Acquisition Function which iteratively explores the surrogate model to look for expected improvements and upper confidence bounds. In other words, based on the objective function we are trying to optimize (performance of the WLAN), the Bayesian Optimizer finds the best EDCA timer set for each AC based on a given set of input variables (the input conditions it observes at any given moment on the WLAN)-novel.

In various embodiments, once the Bayesian Optimizer has converged the model can be exploited. Here, the trained inference model is deployed to the AP which allows it to classify the input variables (what it sees happening on the WLAN), with an output that provides a suggested EDCA timer set (the output of the inference model). This occurs in real-time. That is, as network conditions change, a different set of EDCA timers will be suggested by the inference model that leads to optimization of the objective function (network performance).

In still more embodiments, once the new EDCA timers have been suggested by the model, a logic mechanism can be employed to decide if the new timers should be pushed to the devices via a broadcast beacon (meaning, all clients will update their EDCA timers). The logic mechanism's role is to determine if the changes would produce sufficient performance improvements to warrant BSS-wide changes to the EDCA timer set. If the decision is to update the EDCA timers because it will produce significant performance improvements, the AP broadcasts a management beacon to all stations and their EDCA timers are updated (novel).

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

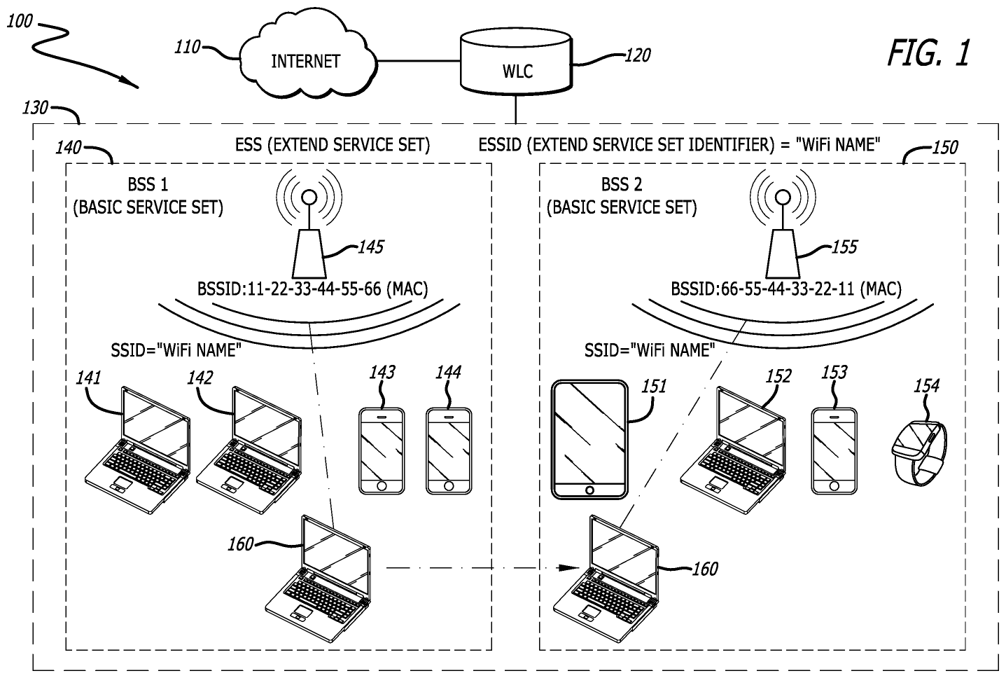

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

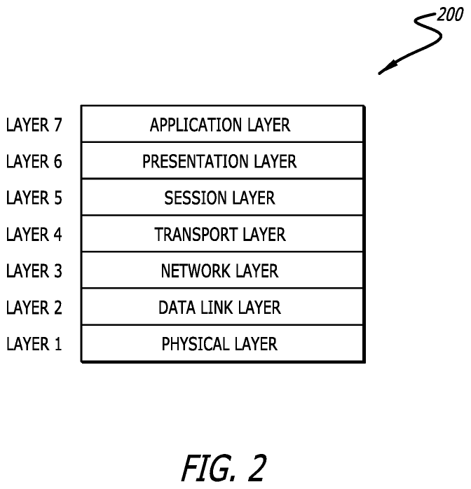

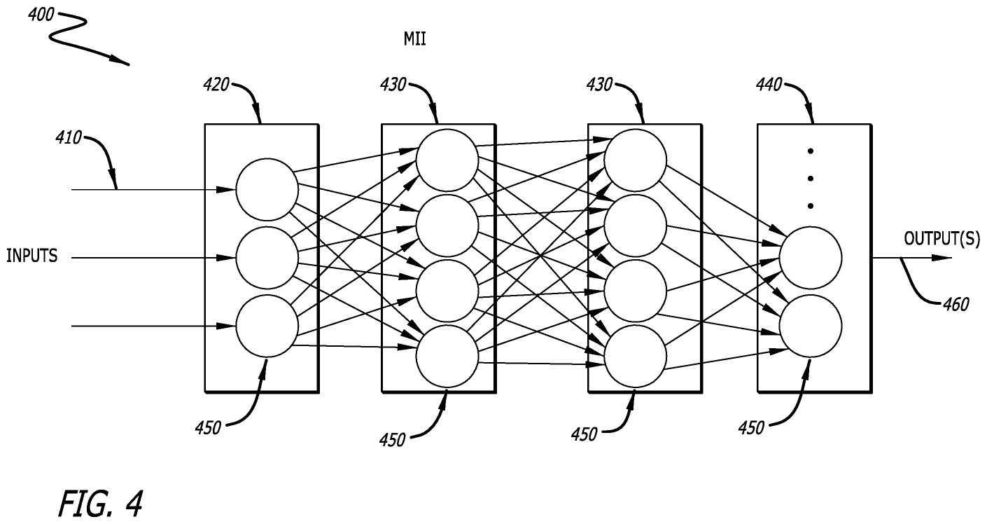

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 4, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “Wi-Fi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-9 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-9 as required to realize a particularly desired embodiment.

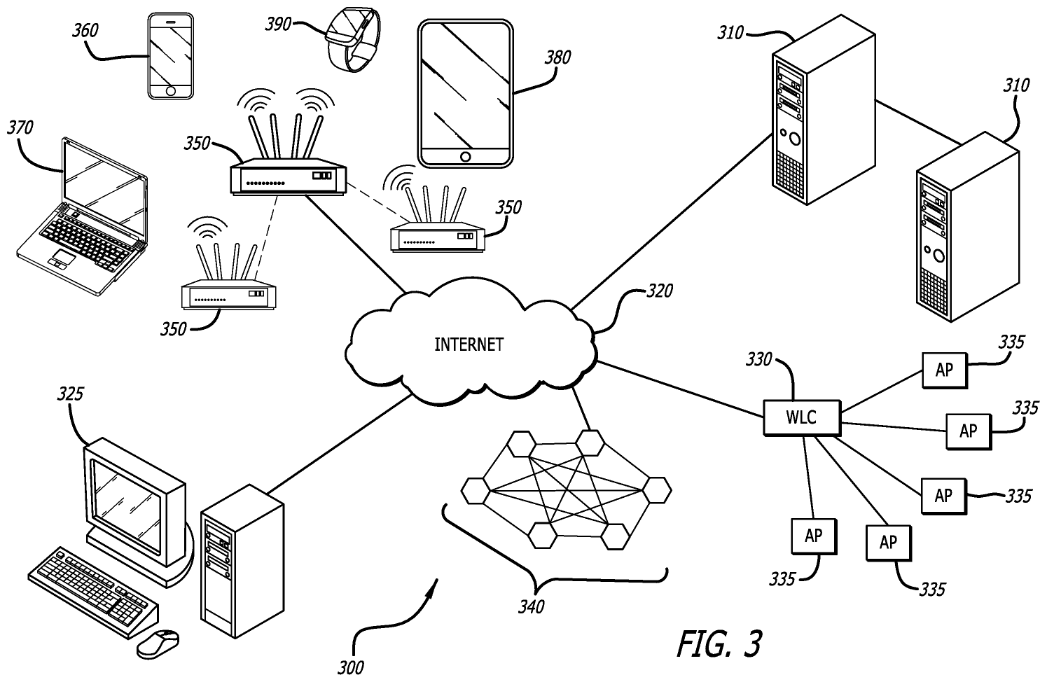

Referring to FIG. 3, a conceptual network diagram 300 of various environments that a networking logic may operate on a plurality of network devices, in accordance with various embodiments of the disclosure is shown. Those skilled in the art will recognize that the networking logic can include various hardware and/or software deployments and can be configured in a variety of ways. In many embodiments, the networking logic can be configured as a standalone device, exist as a logic in another network device, be distributed among various network devices operating in tandem, or remotely operated as part of a cloud-based network management tool. In further embodiments, one or more servers 310 can be configured with the networking logic or can otherwise operate as the networking logic. In many embodiments, the networking logic may operate on one or more servers 310 connected to a communication network 320 (shown as the “Internet”). The communication network 320 can include wired networks or wireless networks. The networking logic can be provided as a cloud-based service that can service remote networks, such as, but not limited to a deployed network 340.

However, in additional embodiments, the networking logic may be operated as a distributed logic across multiple network devices. In the embodiment depicted in FIG. 3, a plurality of network access points (APs) 350 can operate as the networking logic in a distributed manner or may have one specific device operate as the networking logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the networking logic may be integrated within another network device. In the embodiment depicted in FIG. 3, a wireless LAN controller (WLC) 330 may have an integrated networking logic that the WLC 330 can use to monitor or control power consumption of the APs 335 that the WLC 330 is connected to, either wired or wirelessly. In still more embodiments, a personal computer 325 may be utilized to access and/or manage various aspects of the networking logic, either remotely or within the network itself. In the embodiment depicted in FIG. 3, the personal computer 325 communicates over the communication network 320 and can access the networking logic of the servers 310, or the network APs 350, or the WLC 330.

Although a specific embodiment for various environments that the networking logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the networking logic may be provided as a device or software separate from the WLC 330 or the networking logic may be integrated into the WLC 330. The elements depicted in FIG. 3 may also be interchangeable with other elements of FIGS. 1-2 and FIGS. 4-9 as required to realize a particularly desired embodiment.

Referring to FIG. 4, a conceptual illustration of an artificial neural network 400, in accordance with various embodiments of the disclosure is shown. As those skilled in the art will recognize, various methods of machine learning models can be utilized to achieve desired outcomes efficiently. For example, some embodiments may utilize decisions trees, random forests, support vector machines, naïve Bayes, or K-nearest neighbors algorithms. However, artificial neural networks have increased in popularity, especially in deep learning techniques where detection of complex patterns in data and the ability to solve a wide range of problems has been desired. In various embodiments, an artificial neural network may be utilized. Artificial neural networks are a type of machine learning model inspired by the structure and function of the human brain, and often consist of three main types of layers: the input layer, the output layer, and one or more intermediate (also called hidden) layers.

In many embodiments, the input layer is responsible for receiving input data, which could be anything from an image to a text document to numerical values. Each input feature can be represented by a node in the input layer. Conversely, the output layer is often responsible for producing the output of the network, which could be, for example, a prediction or a classification. The number of nodes in the output layer can depend on the task at hand. For example, if the task is to classify images into ten different categories, there would be ten nodes in the output layer, each representing a different category.

In a number of embodiments, the intermediate layers are where the specialized connections are made. These intermediate layers are responsible for transforming the input data in a non-linear way to extract meaningful features that can be used for the final output. In various embodiments, a node in an intermediate layer can take as an input a weighted sum of the outputs from the previous layer, apply a non-linear activation function to it, and pass the result on to the next layer. The weights of the connections between nodes in the layers are learned during training. This training can utilize backpropagation, which may involve calculating the gradient of the error with respect to the weights and adjusting the weights accordingly to minimize the error.

In various embodiments, at a high level, the artificial neural network 400 depicted in the embodiment of FIG. 4 includes a number of inputs 410, an input layer 420, one or more intermediate layers 430, and an output layer 440. The artificial neural network 400 may comprise a collection of connected units or nodes called artificial neurons 450, which loosely model the neurons in a biological brain. Each connection, like the synapses in a biological brain, can transmit a signal from one artificial neuron to another. An artificial neuron that receives a signal can process the signal and then trigger additional artificial neurons within the next layer of the neural network. As those skilled in the art will recognize, the artificial neural network 400 depicted in FIG. 4 is shown as an illustrative example, and various embodiments may comprise artificial neural networks that can accept more than one type of input and can provide more than one type of output.

In additional embodiments, the signal at a connection between artificial neurons is a value, and the output of each artificial neuron is computed by some nonlinear function (called an activation function) of the sum of the artificial neuron's inputs. Often, the connections between artificial neurons are called “edges” or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals propagate from the first layer (the input layer 420) to the last layer (the output layer 440), possibly after traversing one or more intermediate layers (also called hidden layers) 430.

In further embodiments, the inputs to an artificial neural network may vary depending on the problem being addressed. In object detection for example, the inputs may be data representing values for certain corresponding actual measurements or values within the object to be detected. In one embodiment, the artificial neural network 400 comprises a series of hidden layers in which each neuron is fully connected to neurons of the next layer. The artificial neural network 400 may utilize an activation function such as sigmoid, nonlinear, or a rectified linear unit (ReLU), upon the sum of the weighted inputs, for example. The last layer in the artificial neural network may implement a regression function to produce the classified or predicted classifications output for object detection as output 460. In further embodiments, a sigmoid function can be used, and the prediction may need raw output transformation into linear and/or nonlinear data.

Although a specific embodiment for an artificial neural network machine learning model suitable for carrying out the various steps, processes, methods, and operations described herein is discussed with respect to FIG. 4, any of a variety of systems and/or processes may be utilized in accordance with embodiments of the disclosure. For example, the artificial neural network may be external operated, such as through a cloud-based service, or a third-party service. The elements depicted in FIG. 4 may also be interchangeable with other elements of FIGS. 1-3 and FIGS. 5-9 as required to realize a particularly desired embodiment.

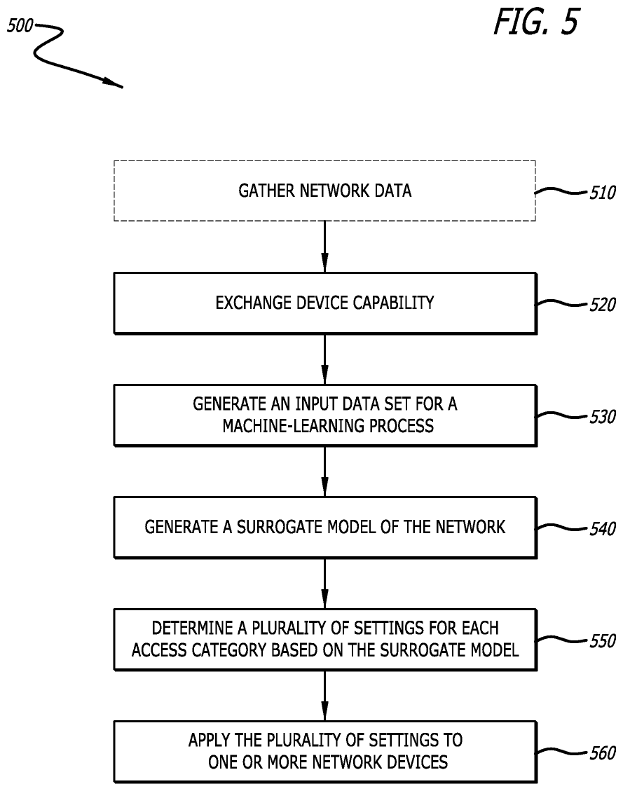

Referring to FIG. 5, a flowchart depicting a process 500 for machine-learning based optimization of enhanced distributed channel access in accordance with various embodiments of the disclosure is shown. In some optional embodiments, the process 500 can gather network data (block 510). The network data can be of various types including, but not limited to, telemetry data, topology data, historical data, model data, parameter data, etc. This data can be acquired, but may be provided by another network device or other database.

In many embodiments, the process 500 can exchange device capability (block 520). Those skilled in the art will recognize that a variety of capabilities may be exchanged, or otherwise transmitted to external network devices. These capabilities may include, but are not limited to, the ability to engage in EDCA modes, etc. This exchange can be incorporated into one or more pre-existing data transfers, such as inserted this data into one or more frames.

In a number of embodiments, the process 500 can generate an input data set for a machine-learning process (block 530). The input data of a machine learning model may comprise a variety of data types. As those skilled in the art will recognize, the more input data that can be provided, the more robust and accurate a model generated by the machine-learning process(es) can be. Often, there is a trade-off with computational resources and/or stale or ungrounded data. In some embodiments, the input data may include, but is not limited to, topology data, telemetry data, parameter data, collision rates, transfer success rates, background noise, historical data, the number of devices being serviced, the applications being utilized, quality of service policies, interference, etc.

In more embodiments, the process 500 can generate a surrogate model of the network (block 540). The surrogate model can be utilized to approximate the relationships between the input variables and the objective function (which is often overall network performance). The surrogate model can be stored and utilized for future decisions. However, the surrogate model can be generated after a certain period of time or event that indicates that the surrogate model is stale and should be regenerated.

In additional embodiments, the process 500 can determine a plurality of settings for each access category based on the surrogate model (block 550). These settings can be determined from processing data within the surrogate model. In more embodiments, the trained surrogate model can be utilized to generate an optimization function which can applied to find a variety of EDCA timer sets or other EDCA parameters.

In further embodiments, the process 500 can apply the plurality of settings to one or more network devices (block 560). Once generated, the plurality of settings/parameters can be applied to other network devices within the local network. For example, a plurality of EDCA parameters, such as different modes of operations on a per-category basis, can be applied to improve overall network performance.

Although a specific embodiment for a process 500 for machine-learning based optimization of enhanced distributed channel access suitable for carrying out the various steps, processes, methods, and operations described herein is discussed with respect to FIG. 5, any of a variety of systems and/or processes may be utilized in accordance with embodiments of the disclosure. For example, the network data may already be provided to the process 600 such that gathering is not necessary. The elements depicted in FIG. 5 may also be interchangeable with other elements of FIGS. 1-4 and FIGS. 6-9 as required to realize a particularly desired embodiment.

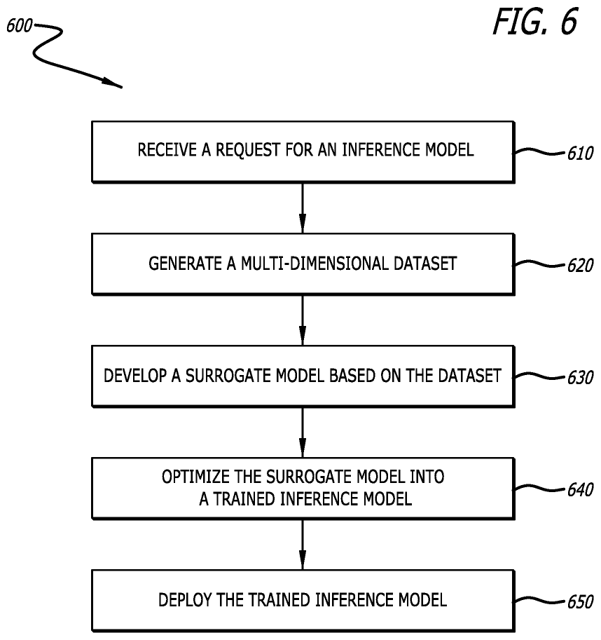

Referring to FIG. 6, a flowchart depicting a process 600 for deploying a trained inference model in accordance with various embodiments of the disclosure is shown. In many embodiments, the process 600 can receive a request for an inference model (block 610). This request can be made by a remote or otherwise external network device. In some embodiments, the network device tasked with setting up one or more EDCA parameters can be configured such that the computational resources required to generate a model are insufficient. In these embodiments, a remote device or service may be utilized to offload one or more steps.

In a number of embodiments, the process 600 can generate a multi-dimensional dataset (block 620). As described above, the input dataset used may include, but is not limited to, topology data, telemetry data, parameter data, collision rates, transfer success rates, background noise, historical data, the number of devices being serviced, the applications being utilized, quality of service policies, interference, etc. As different pieces of data are determined to have one or more relationships, the dataset can become increasingly multi-dimensional.

In more embodiments, the process 600 can develop a surrogate model based on the dataset (block 630). As also described above, a surrogate model can be configured as a model that approximates the relationships between the input dataset and the objective function which can be to generate a plurality of EDCA parameters that can better optimize network performance.

In additional embodiments, the process 600 can optimize the surrogate model into a trained inference model (block 640). In various embodiments, a Bayesian optimizer may be utilized with an acquisition function which can iteratively explore the surrogate model to look for improvements and upper confidence bounds. Upon converging, the surrogate model can be deployed as a trained inference model.

In further embodiments, the process 600 can deploy the trained inference model (block 650). For example, the trained inference model can be deployed onto an AP which can be configured to classify a plurality of input data, variables, parameters, etc. to generate an output that can provide one or more suggested EDCA parameters. In many embodiments, this can occur in real-time or near real-time. As a result, in certain embodiments, as network conditions change, dynamic changes in the EDCA parameters can be determined and applied to provide more optimal network performance.

Although a specific embodiment for a process 600 for deploying a trained inference model suitable for carrying out the various steps, processes, methods, and operations described herein is discussed with respect to FIG. 6, any of a variety of systems and/or processes may be utilized in accordance with embodiments of the disclosure. For example, the trained inference model can be utilized as a cloud-based service in some embodiments. In further embodiments, the trained inference model can be deployed onto a network device, such as a WLAN controller that can generate and provide parameter settings to a plurality of APs or other network devices. The elements depicted in FIG. 6 may also be interchangeable with other elements of FIGS. 1-5 and FIGS. 7-9 as required to realize a particularly desired embodiment.

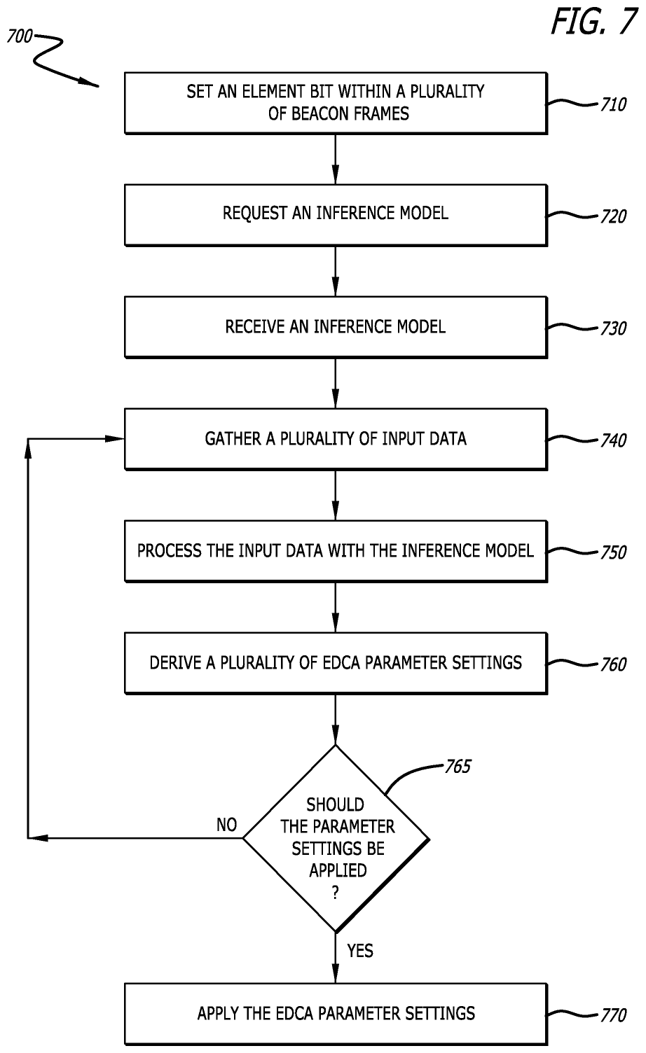

Referring to FIG. 7, a flowchart depicting a process 700 for utilizing inference models to derive enhanced distributed channel access parameters in accordance with various embodiments of the disclosure is shown. In many embodiments, the process 700 can set an element bit within a plurality of beacon frames (block 710). Changing a bit within a beacon frame could involve altering specific parameters or signaling bits, potentially influencing various aspects of network behavior. Modifying bits within beacon frames can be part of fine-tuning strategies to enhance efficiency, accommodate different applications, or address specific challenges in their wireless environment. In certain embodiments, the element bit can be association with a high throughput (HT+) capabilities element bit to indicate availability to or to request to allow for optimization.

In a number of embodiments, the process 700 can request an inference model (block 720). The request can be to a remote-based service, a manufacturer, or to another network device. In some embodiments, the process 700 may not make a direct request but conduct one or more actions that indicate that an inference model would be desired.

In more embodiments, the process 700 can receive an inference model (block 730). As described above, the process 700 can receive a trained inference model from a source such as, but not limited to, a remote-based service, or another network device. In some embodiments, the process 700 may already have an inference model and is just requesting an updated inference model.

In additional embodiments, the process 700 can gather a plurality of input data (block 740). As described above, the input dataset used may include, but is not limited to, topology data, telemetry data, parameter data, collision rates, transfer success rates, background noise, historical data, the number of devices being serviced, the applications being utilized, quality of service policies, interference, etc. This data may be present, or may be requested from other source such as, but not limited to, another network device, or remote-based service.

In further embodiments, the process 700 can process the input data with the inference model (block 750). In various embodiments, the processing is done through one or more machine-learning-based models, which may include, but is not limited to, an inference model. The processing can be done in real-time or near real-time. In some embodiments, the processing can be done in response to an event or period of time elapsing.

In still more embodiments, the process 700 can derive a plurality of EDCA parameter settings (block 760). As discussed above, the EDCA parameters can include various timers related to contention windows. This can be further related to priority and involve deriving a dynamically changing set of parameters in response to various network conditions, and in certain embodiments, to predicted upcoming network conditions. The EDCA methods can be configured to parse data into two or more categories, however many embodiments will utilize four or more. The plurality of EDCA parameter settings can be configured such that each category is associated with a unique setting, or at least provides variable parameters for each category, even if some categories have similar or overlapping specific parameter values at any given moment.

In response, certain embodiments of the process 700 can determine if the parameter settings should be applied (block 765). Depending on various factors, there may be instances where the suggested parameter settings may not be applied or should not be applied. In these instances, the process 700 can again gather a plurality of input data (block 740). However, when it is determined that the parameter settings can be applied, the process 700 can apply those EDCA parameter settings (block 770). In various embodiments, the settings being applied are on a per-category or per-class basis.

Although a specific embodiment for a process 700 for utilizing inference models to derive enhanced distributed channel access parameters suitable for carrying out the various steps, processes, methods, and operations described herein is discussed with respect to FIG. 7, any of a variety of systems and/or processes may be utilized in accordance with embodiments of the disclosure. For example, in some embodiments the process 700 can already have access to a deployed inference model and may not need to request and/or receive one. The elements depicted in FIG. 7 may also be interchangeable with other elements of FIGS. 1-6 and FIGS. 8-9 as required to realize a particularly desired embodiment.

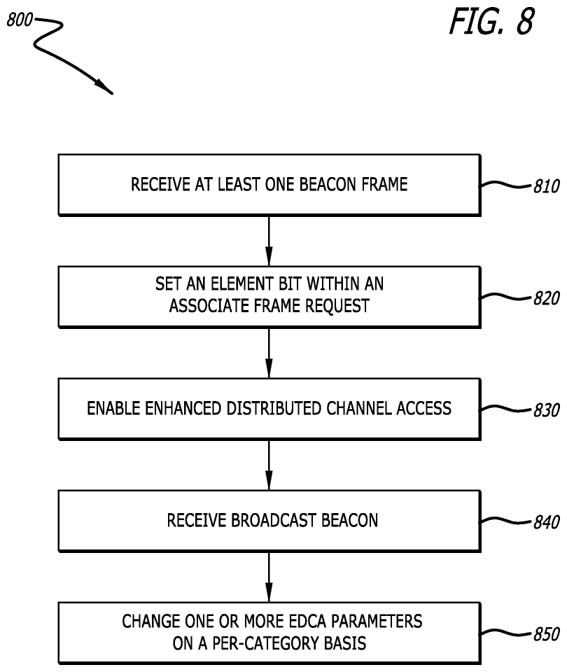

Referring to FIG. 8, a flowchart depicting a process 800 for changing enhanced distributed channel access parameters on a per-category basis in accordance with various embodiments of the disclosure is shown. In many embodiments, the process 800 can receive at least one beacon frame (block 810). As previously discussed, a beacon frame can be transmitted from various APs that can have one or more bits selected that are configured to indicate their capabilities. Some of those capabilities may be the ability to engage in high throughput (HT+).

In a number of embodiments, the process 800 can set an element bit within an associate frame request (block 820). Similar to the received beacon frame, the process 800 can modify one or more bits of an associate frame request to also indicate capabilities. These capabilities may also include the ability to engage in one or more higher throughput modes and/or utilize enhanced distributed channel access.

In more embodiments, the process 800 can enable enhanced distributed channel access (block 830). Once the process 800 has verified that EDCA can be enabled with another network device, such as an AP, the process 800 can begin to transmit and receive data utilizing this protocol. In some embodiments, this can be enabled after another specific event or after an elapsed period of time.

In additional embodiments, the process 800 can receive one or more broadcast beacons (block 840). As those skilled in the art will recognize, a broadcast beacon can be received by various APs within a given wireless network area. The broadcast beacon can be configured to include various suggested parameter settings that can be applied to one or more parameters. In some embodiments, this parameter data can be provided through other means, frames, or other data transfers.

In further embodiments, the process 800 can change one or more EDCA parameters on a per-category basis (block 850). Upon receiving parameter data, often from an access point or other network device, they can be applied by the process 800 prior to or subsequent to data transfers occur. In certain embodiments, the parameter data is configured such that different parameters can be applied to different categories of EDCA configurations. In this way, the process 800 can treat each category of data differently depending on the current needs of the network.

Although a specific embodiment for a process 800 for changing enhanced distributed channel access parameters on a per-category basis suitable for carrying out the various steps, processes, methods, and operations described herein is discussed with respect to FIG. 8, any of a variety of systems and/or processes may be utilized in accordance with embodiments of the disclosure. For example, some embodiments of the process 800 can continue to receive updated parameter data and dynamically adjust in response to events or periods of time elapsing. In further embodiments, the process 800 may additionally request updated parameters in response to events, etc. The elements depicted in FIG. 7 may also be interchangeable with other elements of FIGS. 1-7 and FIG. 9 as required to realize a particularly desired embodiment.

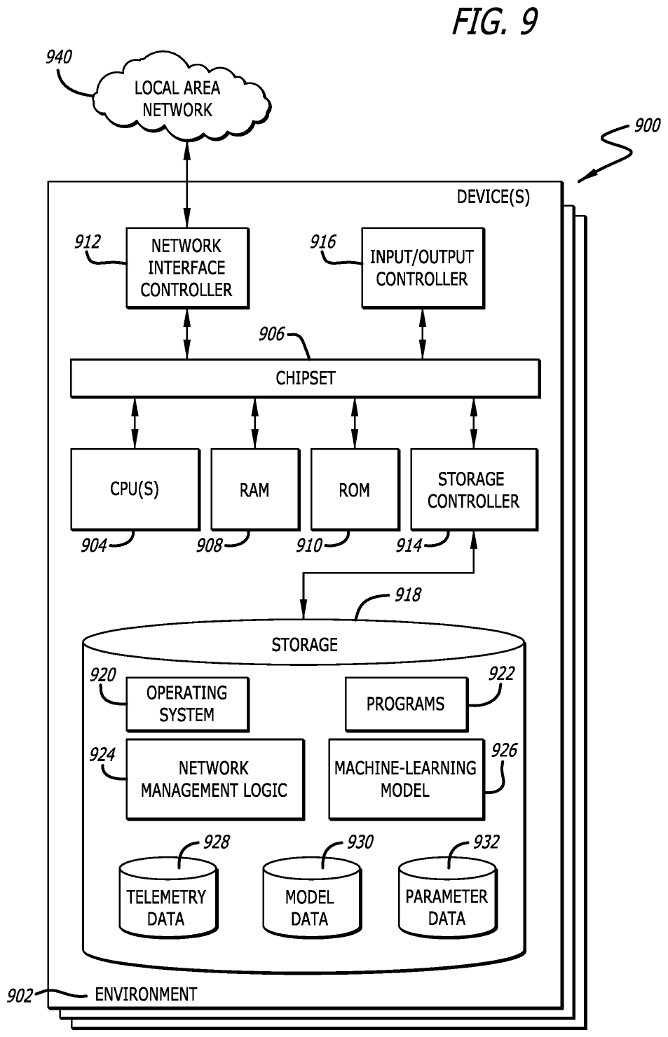

Referring to FIG. 9, a conceptual block diagram of a device 900 suitable for configuration with a network management logic, in accordance with various embodiments of the disclosure is shown. The embodiment of the conceptual block diagram depicted in FIG. 9 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include a network management logic 924. The network management logic 924 can be configured to perform one or more of the various steps, processes, operations, and/or other methods that are described above. Often, the network management logic 924 can be a set of instructions stored within a non-volatile memory that, when executed by the processor(s)/controller(s) 904 can carry out these steps, etc. In some embodiments, the network management logic 924 may be a client application that resides on a network-connected device, such as, but not limited to, a server, switch, personal or mobile computing device in a single or distributed arrangement.

In some embodiments, telemetry data 928 can encompass real-time measurements crucial for monitoring and optimizing network performance. It may include details like bandwidth usage, latency, packet loss, and error rates, providing insights into data transmission quality and identifying potential issues. Telemetry data 928 may also cover traffic patterns and application performance, supporting capacity planning and ensuring optimal user experience. The collection and analysis of this data are essential for proactive network management, facilitated by advanced monitoring tools and technologies. In further embodiments, the telemetry data 928 can include historical data related to past network activity. As described above, telemetry data 928 may also be configured to capture and include values related to topology data, collision rates, transfer success rates, background noise, the number of devices being serviced, the applications being utilized, quality of service policies, or interference.

In various embodiments, model data 930 can comprise information detailing the physical or logical arrangement of network devices and their interconnections. As those skilled in the art will recognize, model data 930 or modeling data may comprise feature selection or extraction, relevant input variables, and other raw data. In some embodiments, the model data 930 may be subject to data cleaning and preprocessing which can address issues like missing values, outliers, and normalization to ensure the data is suitable for effective model training or inference generation. The model data 930 can often be divided into training, validation, and testing sets, facilitating a model's learning, tuning, and evaluation phases. The model data 928 may also include models themselves, which can vary in architecture, ranging from linear regression to more complex structures like neural networks, based on the nature of the problem and dataset characteristics. The model data 928 may also be comprise a training set of data. In some embodiments, model data 928 may further include a model's performance or validation data.

In a number of embodiments, parameter data 932 may comprise detailed information about the settings involved with high throughput data transfers. As described above, various processes can be utilized, including EDCA methods. In these types of methods, the data can be separated into various categories. The parameter data 932 may provide unique settings for each of the categories. These values may be associated with one or more contention window settings, such as the minimum and/or maximum window setting values. In more embodiments, the parameter data 932 may comprise values related to arbitration interframe spaces, and transmission opportunities for each access category. Those skilled in the art will recognize that the specific parameters may vary based on the high throughput data transfer methods utilized.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the telemetry data 928, the power topology data 930, and the station data 932. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for a device suitable for configuration with the network management logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or APs. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network; and
a memory communicatively coupled to the processor, wherein the memory comprises a network management logic that is configured to:
transmit one or more beacon frames;
gather a plurality of input data;
process the input data through one or more machine-learning-based models;
derive a plurality of data transmission settings; and
transmit the plurality of data transmission settings to at least one network device.

2. The device of claim 1, wherein the one or more beacon frames is modified to indicate a capacity for high throughput operation.

3. The device of claim 1, wherein input data comprises at least one of: telemetry data, historical data, or parameter data.

4. The device of claim 3, wherein telemetry data may comprise at least one of: collision rates, transfer success rates, background noise, a quantity of devices being serviced, one or more applications being utilized, quality of service policies, or interference.

5. The device of claim 1, wherein the one or more machine-learning-based models is an inference model.

6. The device of claim 5, wherein the network management logic is further configured to receive the inference model prior to processing the input data.

7. The device of claim 6, wherein the inference model is received in response to a request transmitted by the device.

8. The device of claim 1, wherein the plurality of data transmission settings are associated with an enhanced distributed channel access (EDCA) method.

9. The device of claim 8, wherein the EDCA method is configured to parse transmitted data into two or more categories.

10. The device of claim 9, wherein the plurality of data transmission settings are configured to provide unique settings for each of the two or more categories.

11. The device of claim 9, wherein the plurality of data transmission settings are configured to provide unique settings for at least two of the two or more categories.

12. The device of claim 11, wherein the plurality of data transmission settings are associated with contention window timings.

13. The device of claim 1, wherein network management logic is further configured to transmit data to the at least one network device utilizing an enhanced distributed channel access (EDCA) method.

14. A device, comprising:
a processor;
at least one network interface controller configured to provide access to a network; and
a memory communicatively coupled to the processor, wherein the memory comprises a network management logic that is configured to:
receive at least one beacon frame;
indicate a capability for high throughput data transmission;
enable a high throughput data transmission mode;
receive a plurality of data transmission settings associated with the high throughput data transmission; and
change one or more parameters of the high throughput data transmission mode.

15. The device of claim 14, wherein indicating a capability for high throughput data transmission comprises setting an element bit within an associate frame request.

16. The device of claim 14, wherein the high throughput data transmission mode is an enhanced distributed channel access (EDCA) method.

17. The device of claim 16, wherein the EDCA method parses data for transmission into two or more categories.

18. The device of claim 17, wherein the plurality of data settings are configured to direct a change in each of the two or more categories.

19. The device of claim 18, wherein the network management logic is further configured to transmit data utilizing the high throughput transmission mode.

20. A method of managing a network, comprising:
transmitting one or more beacon frames;
selecting a high throughput data transmission mode wherein the data selected for transmission is separated into two or more categories;
gathering a plurality of input data associated with the high throughput data transmission mode;
processing the input data through one or more machine-learning-based models;
deriving a plurality of data transmission settings, wherein the plurality of data transmission settings are configured on a per-category basis; and
transmitting the plurality of data transmission settings to at least one network device.
